(19) United States
(12) Patent Application Publication
(10) Pub. No.: US 2026/0363201 A1
(43) Pub. Date: Nov. 19, 2026

(54) ELEVATED COT

(71) Applicant: The Pet Cot Company, O'Fallon, MO (US)

(72) Inventor: Greg Squires, St. Peters, MO (US)

(21) Appl. No.: 19/664,299

(22) Filed: Apr. 30, 2026

Related U.S. Application Data
(60) Provisional application No. 63/797,683, filed on Apr. 30, 2025.

(51) Int. Cl. A01K 1/035; A01K 1/00

(52) U.S. Cl. CPC A01K 1/0353; A01K 1/0052

(57) ABSTRACT

An elevated cot includes a frame assembly with legs and a perimeter frame supported on the legs. The legs support the perimeter frame at an elevated position. A support sheet is stretched over the perimeter frame at the elevated position. At least a portion of the support sheet is made of permeable fabric such that the support sheet defines a vent. A fan can move air at a position below the elevated position. A ducting panel extends from the fan to the support sheet. The ducting panel defines a plenum fluidly connecting the fan to the vent. The plenum can guide air moved by the fan through the vent for cooling an area above the support sheet.

### CROSS-REFERENCE

This application claims priority to US Provisional Patent Application No. 63/797,683, entitled ELEVATED COT, filed Apr. 30, 2025, which is hereby incorporated by reference in its entirety for all purposes.

### FIELD

The present disclosure relates generally to an elevated cot, specifically an elevated cot with a fan for cooling a body resting on the cot.

### BACKGROUND

Cots support users such as humans and animals when, for example, they are at rest (e.g., seated, lying down, sleeping, etc.). In general, cots include a flexible support sheet that is held in tension on a frame. Frames can include corner connectors that interconnect an arrangement of perimeter side members. Some cots include frames that encapsulate edges of the support sheet to limit wear.

Flexible support sheets such as those used in cots may be porous, allowing the movement of air through the support sheet. Movement of air through the support sheet may be useful in cooling a human or animal lying down on the cot.

### SUMMARY

In one aspect, an elevated cot for cooling a pet comprises a frame assembly having legs and a perimeter frame supported on the legs, wherein the legs are configured to support the perimeter frame at an elevated position. The perimeter frame has a support sheet stretched thereover at the elevated position, and at least a portion of the support sheet is made of a permeable fabric such that the support sheet defines a vent through which air can flow. The cot also comprises a ducting panel beneath the support sheet which defines a plenum fluidly connecting the vent to a fan located beneath the elevated position, the plenum being configured to guide air moved by the fan through the vent in order to cool an area above the support sheet.

In another aspect, a fan for cooling an elevated pet bed is disclosed. The pet bed broadly comprises a frame assembly for supporting a support sheet at an elevated position, the frame assembly having a perimeter frame and a perimeter shield surrounding the perimeter frame. The fan has at least one air mover, a housing which receives the at least one air mover, and a clip. The clip is configured to clip onto the perimeter shield to support the fan on one side of the elevated pet cot.

In yet another aspect, a bedding replacement for an elevated pet cot comprises a rectangular support sheet having four looped side margins for receiving four perimeter frame members of a frame assembly of the elevated pet cot to stretch the support sheet on the frame assembly at an elevated position. At least a portion of the support sheet is made of permeable fabric such that the support sheet defines a vent. The bedding replacement also comprises a ducting panel having a length extending from a first end portion to second end portion, the second end portion of the ducting panel being joined to the support sheet a t a joint extending around the vent, wherein the first end portion of the ducting panel is configured to connect to a fan positioned below the support sheet adjacent to one of the looped side margins of the support sheet. The ducting panel is configured to define a plenum for fluidly connecting the fan to the vent, and is configured to guide air moved by the fan to pass through the vent for cooling a pet resting on the support sheet.

Other aspects and features will be apparent hereinafter.

### BRIEF DESCRIPTION OF THE DRAWINGS

FIG. 1 is a perspective view of the cot and a user according to an embodiment.

FIG. 2A is a top plan view of the cot according to an embodiment.

FIG. 2B is a bottom plan view of the cot according to an embodiment.

FIG. 3 is an exploded perspective of the cot according to an embodiment.

FIG. 4 is a perspective of ducting panel and fan of the cot according to an embodiment.

FIG. 5A is a front elevation of the fan according to an embodiment.

FIG. 5B is a rear elevation of the fan according to an embodiment.

FIG. 5C is a side elevation of the fan according to an embodiment.

FIG. 6 is a cross section taken in the plane of 7-7 of FIG. 1.

FIG. 7 is a side view elevation of the fan attached to a portion of the frame assembly.

FIG. 8 is a flow chart of a bedding replacement method according to an embodiment.

FIG. 9 is an exploded perspective of a cot; and

FIG. 10 is a cross section of the cot of FIG. 9.

Reference numerals in the drawings correspond to like elements in the detailed description. Such reference numerals are used to facilitate an understanding of the disclosure and are not intended to be limiting.

### DETAILED DESCRIPTION

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

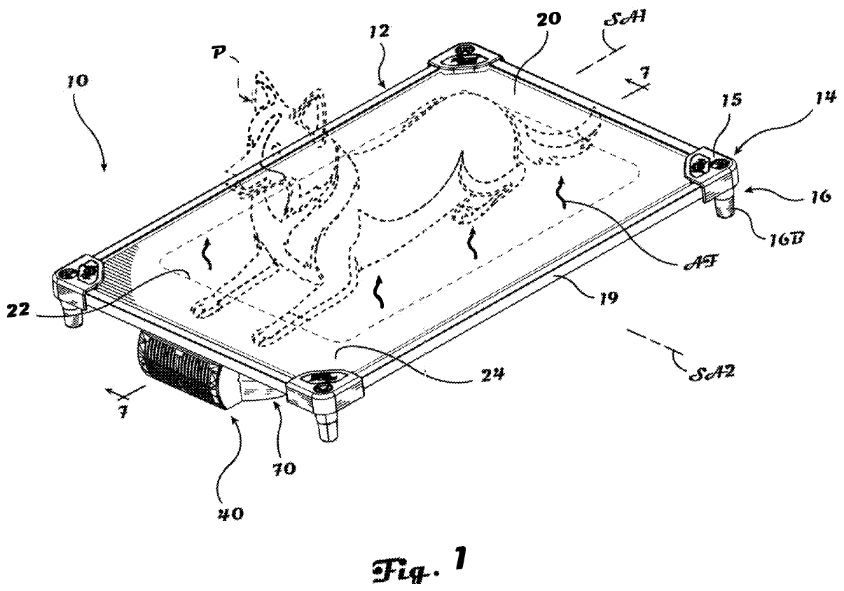

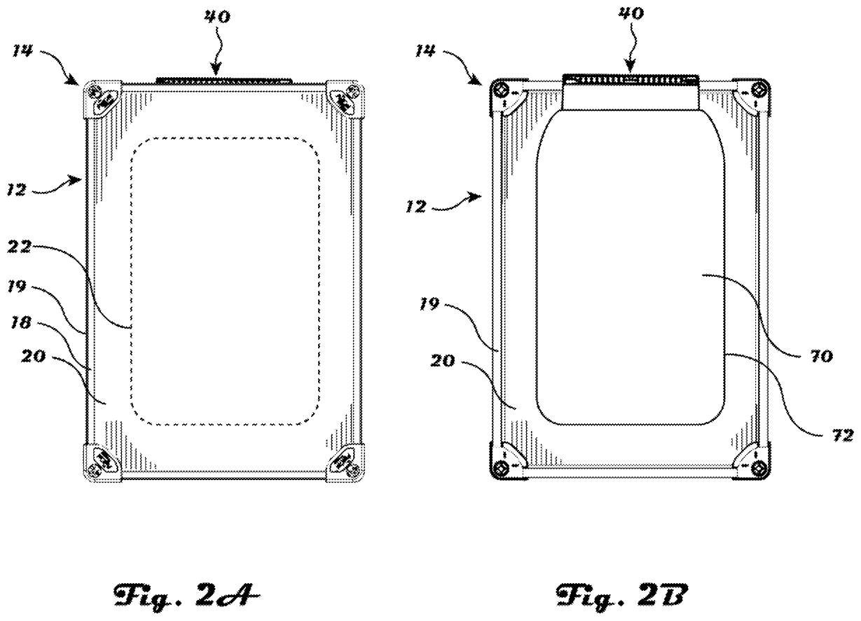

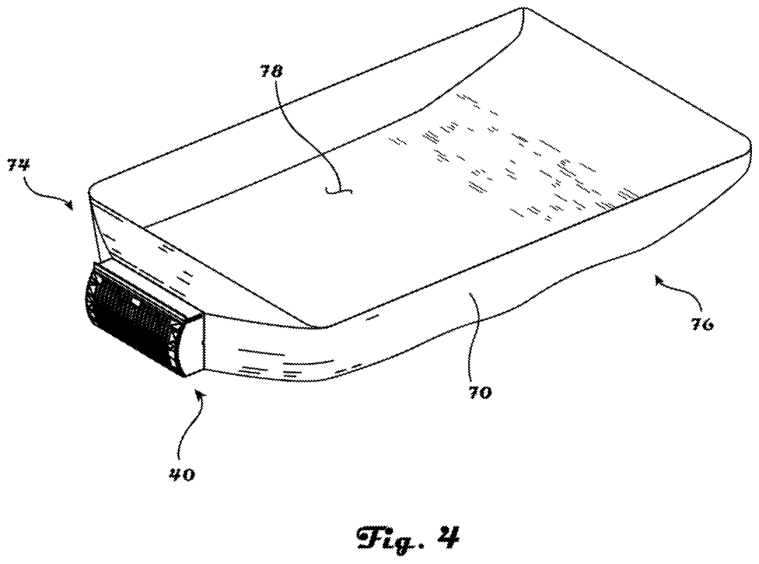

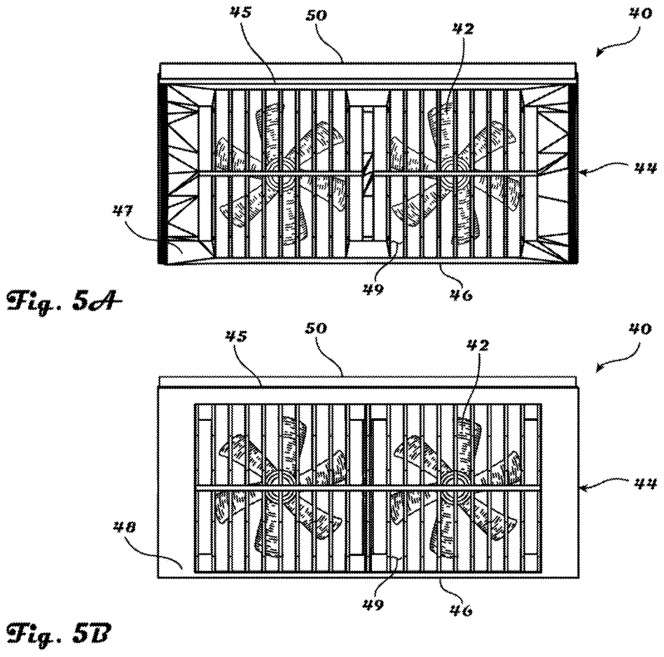

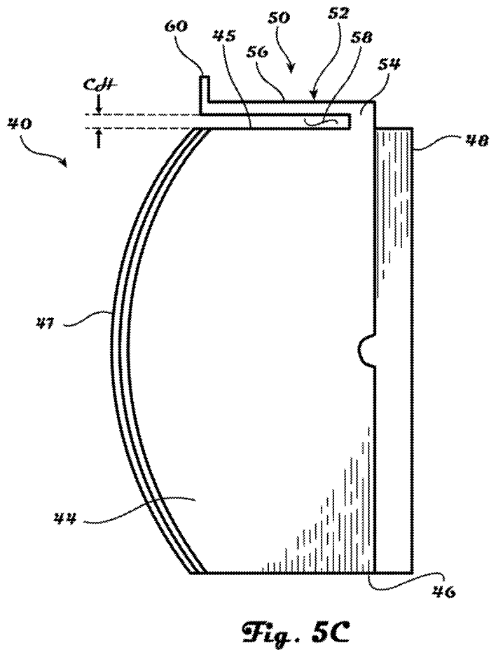

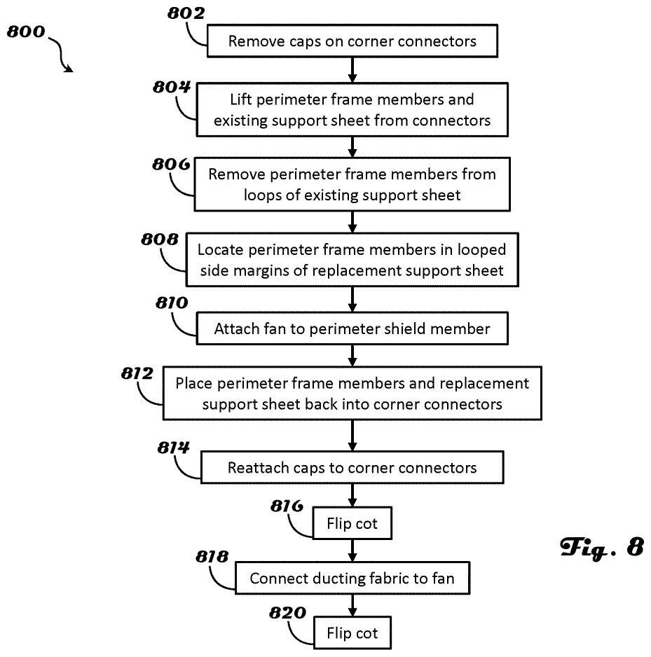

The following disclosure will begin with reference to FIGS. 1-3 for an overview of the cot and its key features. Referring still to FIGS. 1-3, a detailed description of the support sheet will be provided. Then, referring to FIGS. 2-4, the ducting panel and plenum will be described and explained. FIGS. 5-7 will then be referenced for description of the fan. Lastly, FIG. 8 will be referenced for description and explanation of a method according to an embodiment.

Referring to FIGS. 1-3, an elevated cot in accordance with the present disclosure is generally indicated at reference number 10. The cot 10 comprises a frame assembly, generally indicated at 12, and a support sheet 20 stretched over the frame assembly. As explained below, the frame assembly 12 is configured to hold the support sheet 20 in tension so that the support sheet extends generally in a plane that is spaced apart above the underlying support surface of the cot 10 (e.g., the ground, another cot, etc.). Thus, the cot 10 is configured to support a user on the support sheet 20 at an elevated position that is spaced apart above the underlying support surface of the cot. In certain embodiments, such as the illustrated embodiment in FIG. 1, the cot 10 is configured for supporting an animal P such as a companion animal like a dog or cat. But it will be understood that the present disclosure is not strictly limited to cots used for animal bedding. The illustrated cot 10 includes a fan 40 configured to detachably couple to the frame assembly 12. As will be explained in further detail below, the fan 40 is configured to deliver air through the support sheet 20 to the user P by blowing air into a plenum defined by a ducting panel 70 located beneath the support sheet. The support sheet 20 is at least partially composed of a porous material to define a vent 22. Air moved upwardly through the vent 22 may cool a pet P located on top of the support sheet 20 (e.g., the air flow AF of FIG. 1). As will be explained in further detail below, the cot 10 has a modular construction so that various support sheets 20 and accessories such as the fan 40 and ducting panel 70 can be interchangeably installed on the frame assembly.

The frame assembly 12 includes a plurality of perimeter frame members 18 defining a perimeter frame and a plurality of perimeter shield members 19 defining a perimeter shield. The perimeter frame members 18 and perimeter shield members 19 extend between corner connectors 14 of the frame assembly 12. Together, the perimeter frame members 18 and the perimeter shield members 19 form sides of the frame assembly 12 extending along respective side axes SA1, SA2 (FIG. 1). The corner connectors 14 are positioned at corners of the cot 10 and are configured to interconnect the perimeter frame members 18 and perimeter shield members 19 to form the frame assembly 12. In the illustrated embodiment, the frame assembly 12 is rectangular and includes four corner connectors 14 and four perimeter frame members 18 and perimeter shield members 19 forming two pairs of parallel frame assembly sides extending along perpendicular axes SA1, SA2. In other embodiments, the frame assembly 12 could have other polygonal shapes (e.g., triangular, pentagonal, hexagonal, etc.) and/or have other numbers of corner connectors, perimeter frame members, and perimeter shield members. Though the perimeter frame members 18 and perimeter shield members 19 are substantially straight in the illustrated embodiment, in other embodiments the perimeter frame members and perimeter shield members could be curved or otherwise non-straight.

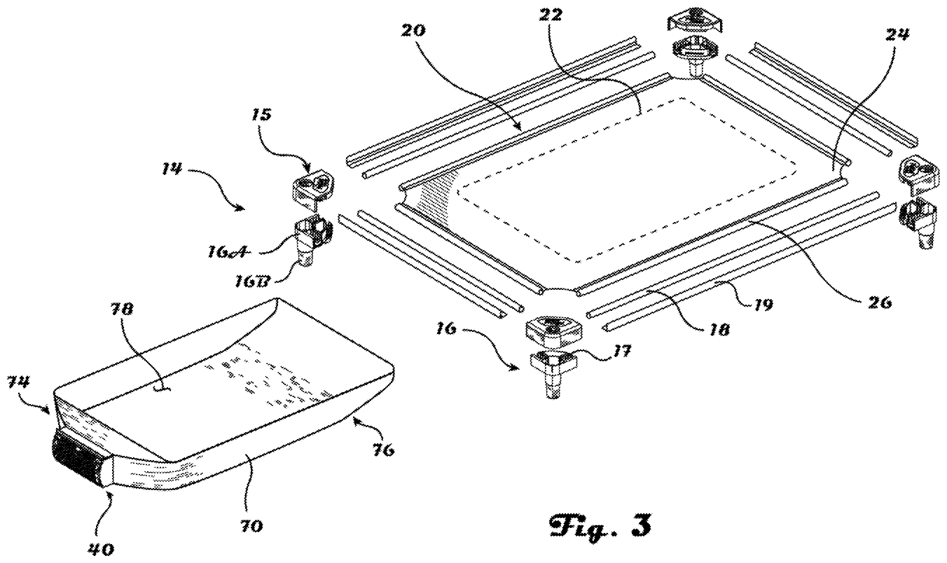

Referring to FIG. 3, the frame assembly 12 includes a plurality of corner connectors 14. Each corner connector 14 includes a bottom portion, generally indicated at 16, and a cap, generally indicated at 15. The illustrated cap 15 is a separate component from the bottom portion 16 and is configured to be attached to the bottom portion.

The bottom portion 16 comprises an upper attachment portion 16A and a leg 16B. In the illustrated embodiment, the leg 16B has a substantially cylindrical shape extending generally along a vertical axis (e.g., an axis generally perpendicular to the support plane of the cot 10). Each leg 16B forms a corner support leg of the cot 10 and defines a bottom end of the bottom portion 16 configured for contact with the underlying support surface. Suitably, the leg 16B has a height that spaces the sides of the frame assembly 12 above the support surface at an elevated position of sufficient height that the support sheet 20 does not contact the underlying support surface when supporting the user. In the illustrated embodiment, the upper attachment portion 16A defines two channels 17, each channel being shaped and sized to receive and retain end regions of a perimeter frame member 18. The corner connector 14 can have the same design as the corner connector described in U.S. Pat. No. 10,898,006, which is hereby incorporated by references. Thus, as explained in U.S. Pat. No. 10,899,006, the bottom portion 16 can further define two L-shaped sockets for matingly receiving end portions of two shield members 19 that extend from the corner connector 14 in the assembled cot. As explained further in U.S. Pat. No. 10,899,006, the frame assembly 12 can be assembled by inserting the end portions of the shield members 19 into the sockets of the corner connector bottom portions 16 to form an intermediate frame subassembly. The frame members 18 can be installed in the looped hems of the support sheet 20 and then the end portions can be loaded vertically into the open-top channels of the corner connector bottom portions 16 in the pre-assembled intermediate frame subassembly.

The cap 15 secures to the top of the bottom portion 16 of the corner connector 14, and may be releasably joined thereto. When the cap 16 is joined to the bottom portion 16, the perimeter frame members 18 and perimeter shield members 19 are held in a stable position therein. In the illustrated embodiment, when each of the four corner connectors 14 are in an assembled (i.e., joined) configuration with the perimeter frame members 18 and perimeter shield members 19 therein, the frame assembly 12 holds the support sheet 20 in a substantially horizontally planar configuration. As will be described in further detail below, the tension of the support sheet 20 pulls the perimeter frame members 18 inwardly (i.e., toward the center of the cot 10), providing greater stability to the cot overall.

Referring to FIGS. 1-3, the support sheet 20 will now be described in greater detail. The support sheet 20 can be formed of any suitable material for supporting a user lying on the cot 10. In general, the support sheet 20 is formed from a thin and flexible material (e.g., a woven or knit fabric, etc.) that is configured for being held in tension by the frame assembly 12. In one embodiment, at least a portion of the support sheet 20 is formed from a breathable fabric, defining a vent 22, so that airflow underneath the cot 10 can provide cooling to a person or animal supported on the support sheet. Referring specifically to FIG. 3, the support sheet 20 has a plurality of corner margins 24 (e.g., four corner margins in the illustrated embodiment) and a plurality of looped side margins 26 (e.g., four side margins in the illustrated embodiment) extending between the plurality of corner margins. Each of the looped side margins 26 defines at least one loop for receiving a perimeter frame member 18. End portions of each perimeter frame member 18 protrude from the looped side margins 26 for being received in the corner connectors 14. As shown in FIGS. 2A and 2B, the corner margins 24 are oriented transverse to the adjacent looped side margins 26 for being captured in the corner connectors 14. In the assembled cot 10, the perimeter shield members 19 and the corner connectors 14 shield the margins 24, 26 of the support sheet 20 against wear. In this sense, the cot 10 is “chew proof” because animals, children, etc. are inhibited from chewing on the edges of the support sheet 20, which can break the connection between the support sheet and the frame assembly 12 and render the cot inoperable.

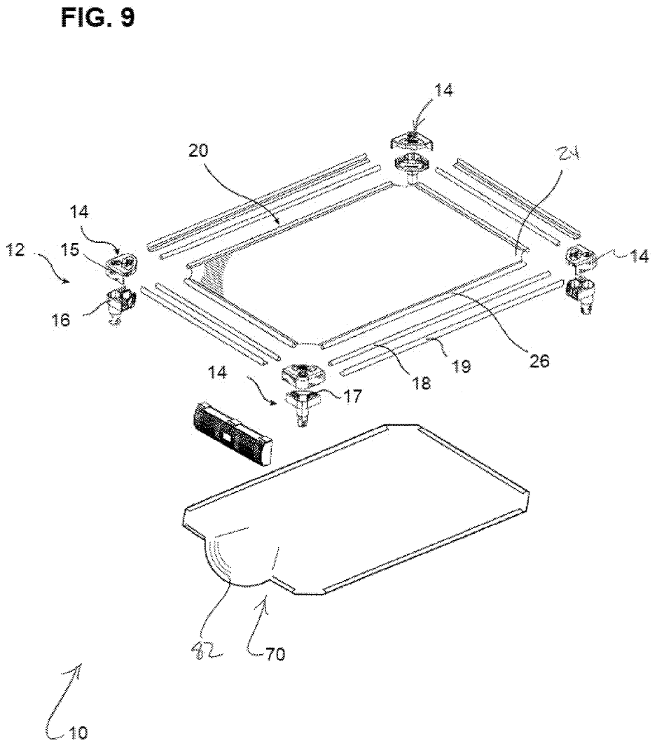

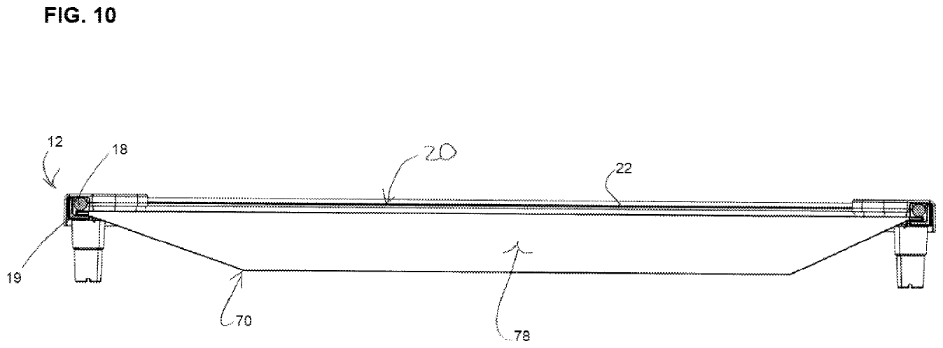

Referring to FIGS. 2-4, the ducting panel 70 will now be described in greater detail. The ducting panel 70 is connected to the fan 40 at a first end portion 74 and to the support sheet 20 at a second end portion 76. The ducting panel 70 defines a plenum 78 fluidly connecting the fan 40 to the support sheet 20. The plenum 78 is configured to guide the flow of air from the fan 40 to the vent 22 in the support sheet 20. Referring specifically to FIG. 2B, the plenum 78 has an upstream end portion 74 where the ducting panel 70 is connected to the fan and a downstream end portion 76 where the ducting panel is connected to the support sheet. The ducting panel 70 is connected to the support sheet 20 at a joint 72 which circumscribes at least a portion of the vent 22. In certain embodiments, the joint 72 is formed by a stitch. In other embodiments, the ducting panel 708 is connected to the support sheet 20 in other ways (one example of which will be described in greater detail below in reference to FIGS. 9 and 10).

While the illustrated embodiment shows the joint 72 and the vent 22 having the same dimension and location with respect to the support sheet 20, the vent and joint may be different shapes and at different locations. From the joint 72, a portion of the ducting panel 70 drapes down under the bottom side of the support sheet 20 and then extends generally horizontally toward the fan 40.

Positive air pressure within the plenum 78 is created by the fan 40 when the fan is active (e.g., blowing). The air blown by the fan 40 into the plenum 78 diffuses through the vent 22. In certain embodiments, the ducting panel 70 and support sheet 20 and/or vent 22 are made from different materials. The ducting panel 70 may be less permeable than either the vent 22 or support sheet 20 such that positive air pressure within the plenum 78 results in diffusion of air through the vent as opposed to through the ducting panel itself. Reduced permeability in the ducting panel 70 may generally correlate with a higher rate of air flow through the vent 22 and, in turn, improved cooling for the user. The ducting panel 70 and/or plenum 78 translates the direction of air flow from a substantially horizontal direction (e.g., near the upstream end portion 74 of the ducting panel) to a substantially vertical direction (e.g., near the downstream end portion 76 of the ducting panel).

Referring to FIGS. 5-7, the illustrated fan 40 is detachably coupled to the frame assembly 12 below the support sheet 20 and is connected to the upstream end portion 74 of the ducting panel 70. The fan 40 includes a housing 44 having an upper wall 45 and lower wall 46 spaced apart vertically, as well as an inlet side 47 and an outlet side 48. Both the inlet side 47 and the outlet side 48 define a plurality of openings 49 for allowing the free flow of air through the housing 44 and into the plenum 78. In the illustrated embodiment (e.g., FIGS. 5A and 5B), the plurality of openings 49 are rectangular apertures extending vertically from near the lower wall 46 of the housing 44 to near the upper wall 45 of the housing, and are spaced longitudinally across both the inlet side 47 and the outlet side 48.

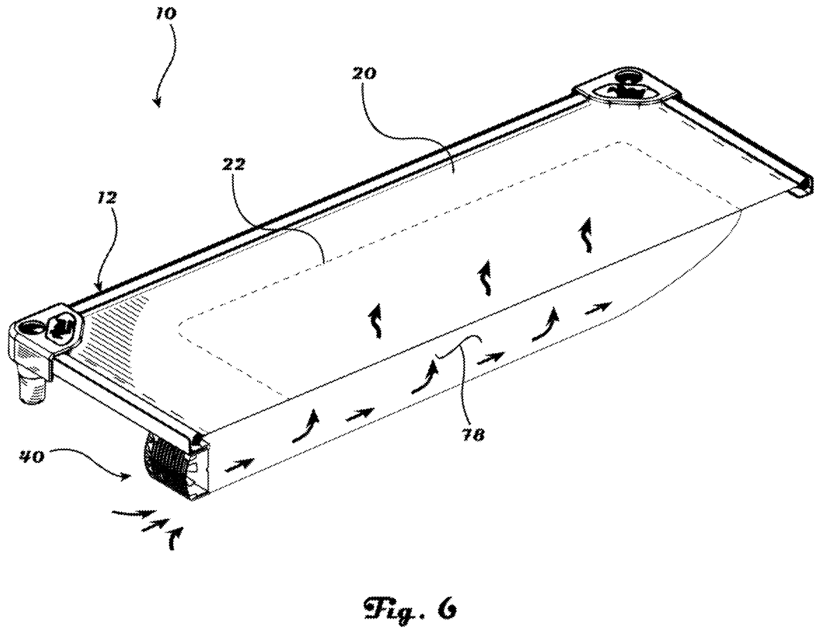

Referring to FIGS. 5A and 5B, the fan 40 includes at least one air mover 42 located within the housing 44 configured to forcibly draw air from outside the plenum 78 into the plenum. In the illustrated embodiment, the at least one air mover 42 comprises two rotary fan members which, when rotating, draw air inwardly to the fan 40 via the plurality of openings 49 at the inlet side 47 and push air outwardly from the fan via the plurality of openings at the outlet side 48. As shown at FIG. 6, movement of air from outside the plenum 78 to within the plenum creates positive pressure within the plenum. As a result, air is forced to exit the plenum 78 through the vent 22, cooling a user on the support sheet.

Referring to FIG. 5C, the fan 40 includes a clip 50 having a clip arm 52 located on the upper wall 45 of the housing 44. The clip 50 is configured to detachably couple to the frame assembly 12. In the illustrated embodiment, the clip 50 is configured to attach to a perimeter shield member 19. The clip 50 is generally L-shaped, having an upstanding segment 54 and a cantilevered segment 56. The upstanding segment 54 protrudes vertically from the upper wall 45 of the housing 44 in proximity to the outlet side 48, and the cantilevered segment 56 extends from the upstanding segment at a substantially perpendicular angle in the direction of the inlet side 48. The cantilevered segment is 56 substantially parallel with the surface of the upper wall 45, defining a rectangular clipping space 58 therebetween.

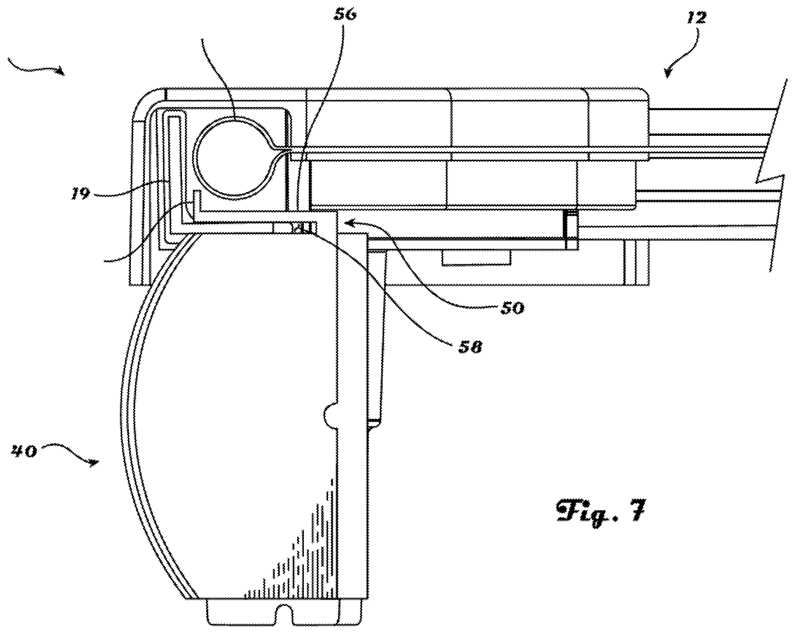

The fan 40 may be detachably coupled to the frame assembly 12 by locating at least a portion of the frame assembly within the clipping space 58. The clip 50 holds the fan 40 in contact with the frame assembly 12 and may keep the lower wall 46 from coming into contact with the underlying support surface of the cot 10 (e.g., the ground, another cot, etc.). In the illustrated embodiment shown in FIG. 7, the fan 40 is clipped to the frame assembly 12 at the perimeter shield member 19. Specifically, a horizontal portion of the L-shaped perimeter shield member 19 is located in the clipping space 58 of the clip 50 such that the cantilevered segment 56 of the clip is sandwiched between the perimeter shield member and the perimeter frame member 18. Thus, the clip 50 is partially located in a gap between a perimeter frame member 18 and the horizontal portion of a perimeter shield member 19. In one embodiment, the clip further includes a lip 60 extending upwardly from the cantilevered segment 56. The lip 60 helps retain the fan on the frame assembly 12.

As is now apparent, this disclosure provides a fan-cooled cot that facilitates mounting a fan on the cot's frame assembly and guiding air from the fan through a plenum so that it is discharged through a vent defined by the major support sheet of the cot. The inventors believe that the above-described fan-cooled cot assembly is advantageous because it is readily achieved by way of modular add-on accessories provided to users of a basic cot after the basic cot has already been deployed. This is achieved by conducting a method for replacing standard cot bedding with fan-cooled cot bedding (or, more broadly, accessorized cot bedding), in accordance with the present disclosure.

Referring now to FIG. 8, an exemplary method for replacing cot bedding (e.g., an existing support sheet 20) will be described, and is generally indicated at 800. A suitable standard cot that can be accessorized by way of the method 800 is disclosed in U.S. Pat. No. 10,898,006, which was previously incorporated by reference herein. In suitable embodiments, the method 800 thus beings with a fully assembled standard cot of the type disclosed in U.S. Pat. No. 10,898,006, which typically has already been put into use for a time. A desire for these embodiments may arise, for example, when a pet owner determines, after providing the standard cot for the pet's use, that the pet would be more comfortable if active cooling were to be provided while the pet is resting on the cot.

At step 802, the caps 15 are removed from the corner connectors 14. Each corner connector 14 includes a cap 15 and a bottom portion 16 on which the cap is supported. As explained above, the bottom portion 16 of each corner connector 14 includes an upper attachment portion 16A with at least one channel 17 for receiving a perimeter frame member 18. The cap 15, when installed, encloses the upper attachment portion 16A, preventing the perimeter frame member 18 and perimeter shield member 19 from exiting the channel 17 and thereby securing the frame assembly 12 in an assembled configuration. By removing the caps 15 on each of the corner connectors 14, each of the perimeter frame members 18 are free to be removed from their nested position in the channels 17.

At step 804, each of the perimeter frame members 18 are lifted from the channels 17. The existing support sheet is lifted with the perimeter frame members 18. By leaving the perimeter shield members 19, they maintain the geometry of the frame assembly 12.

At step 806, the perimeter frame members 18 are removed from the existing support sheet. As explained above, the existing support sheet includes a number of looped side margins 26 within which the perimeter frame members 18 are located. Removing the perimeter frame members 18 from the existing support sheet may include pushing or pulling the perimeter frame members 18 from their position within the loops 26.

At step 808, the perimeter frame members 18 are located in the looped side margins 26 of a replacement support sheet 20. The replacement support sheet 20 is suitably pre-joined to the ducting panel 70. For example, in one or more embodiments, the user acquires a fan accessory kit including the fan 40 and a prefabricated assembly of the support sheet 20 and ducting panel 70. Each of the perimeter frame members 18 is inserted into a respective looped side margin 26 of the replacement support sheet 20 by, for example, holding an end region of a perimeter frame member 18 in one hand, maintaining a loop opening at an open configuration with the other hand, and inserting the perimeter frame member into the looped opening. The existing support 20 sheet may be discarded or stored.

At step 810, the fan 40 is attached to a perimeter shield member 19. To attach the fan 40 to the perimeter shield member 19, a portion of the perimeter shield member (e.g., a horizontal portion) is located in the clipping space 58 of the clip 50. This is generally depicted at FIG. 7.

Referring back to FIG. 8, at step 812, the perimeter frame members 18 and replacement support sheet 20 are reinserted into the frame assembly 12. Each of the end regions of the perimeter frame members 18 are inserted into the channels 17 of the corner connectors 14. In this way, the perimeter frame members 18 are in a nested position with respect to the perimeter shield members 19, and the replacement support sheet 20 maintained in tension at a substantially planar configuration. The support sheet 20, having ducting panel 70 thereunder, should be oriented such that the first end portion 74 (i.e., the portion which connects to the fan 40) is in proximity to the fan.

At step 814, the caps 15 are reattached to the corner connectors 14. In some embodiments, this may include simply placing the caps 15 on top of the upper attachment portion 16A of the bottom portion 16 and pressing downward. By attaching the caps 15 to the bottom portion 16 of the corner connectors 14, each of the perimeter frame members 18 are prevented from leaving their position within the channels 17.

At step 816, the cot 10 is flipped over. This is to provide access to the underside of the cot 10, such as the ducting panel 70 and fan 40. If the fan 40 is pre-connected to the ducting panel 70, this step (as well as steps 818 and 820) may be omitted.

At step 818, the ducting panel 70 is connected to the fan 40 at its first end portion 74. The ducting panel 70 may be joined to the fan 40 in many ways. For example, the ducting panel 70 may be clipped to the outlet side 48 of the fan 40.

At step 820, the cot 10 is flipped over. This is to reorient the cot 10 to an upright position so that a user, such as a pet P, may utilize the cot.

Referring to FIGS. 9-10, in one embodiment, the second end portion of the ducting panel 70 is connected to the support sheet 20 by way of the frame assembly 30 instead of a seam inboard of the frame as shown able. As above, the ducting panel 70 is configured to enclose the plenum 78 between the fan 40 and the vent 22 such that air directed into the plenum through the interior air fitting flows out of the plenum through the vent. In an embodiment, the ducting panel 70 of FIGS. 9-10 is formed from flexible material that is less permeable than the material forming the support sheet 20.

In the illustrated embodiment, the ducting panel 70 is secured to the cot 10 at the frame assembly 12. More specifically, the ducting panel 70 has perimeter side edge margins that are sandwiched between the perimeter frame members 18 and the perimeter shield members 19. In one or more embodiments, each perimeter side edge margin of the ducting panel 80 comprises panel material looped around a thin support bar that helps give the ducting panel its shape and retain the ducting panel on the frame assembly 12. The illustrated ducting panel 70 also comprises perimeter corner margins (which are devoid of support bars in the illustrated embodiment) sandwiched between the bottom portions 16 and the caps 15 of the legs 14.

The ducting panel 70 comprises a fitting region 82 adjacent one of the perimeter side edge margins. The fitting region 82 is configured to be stretched around the fan 40, specifically the plenum adapter 52. By connecting the perimeter edge margin of the ducting panel 80 to the frame assembly 12 and the fan 40 as described above, a joint that circumscribes the vent 22 is established between the ducting panel 70 and the support sheet 20. Further, the ducting panel 70 encloses the plenum 78 below the support sheet 20 so that substantially all air that is directed into the plenum through the interior air fitting 14 is directed to pass out of the plenum through the vent 22 in the support sheet 20.

The above-described accessories provide modular add-on accessories to users of a basic cot for converting the basic cot to a fan-cooled unit. It will be apparent to those skilled in the art that implementation details can vary from the illustrated embodiments described above to suit various basic cot constructions. For example, ducting panels can be secured to the cot by various securements such as fabric compression (e.g., elastic fabric stretched around the cot frame), touch fasteners (e.g., Velcro® hook an loop touch fasteners), zippers, snaps, etc. Similarly, the fan itself can be secured to the cot frame and/or other cot structure (including support sheet) by various securements. In one example, the clip has a different construction for clipping onto a different type of cot frame (e.g., a U-shaped clip that secures over a round or square frame member rather than a shield member). Other fan securements can also be used, e.g., touch fasteners (e.g., Velcro® hook an loop touch fasteners), zippers, snaps, etc. The placement of the fan can also vary from the specific examples shown in the drawings to suit application requirements or other preferences. Furthermore, the principles of the present disclosure can be used with other types of cots besides pet cots (e.g., camping cots) in some embodiments.

As various changes could be made in the above apparatuses, systems, and methods without departing from the scope of the invention, it is intended that all matter contained in the above description and shown in the accompanying drawings shall be interpreted as illustrative and not in a limiting sense.

What is claimed is:

1. An elevated cot comprising:
a frame assembly including legs and a perimeter frame supported on the legs, the legs configured to support the perimeter frame at an elevated position;
a support sheet stretched over the perimeter frame at the elevated position, at least a portion of the support sheet being made of permeable fabric such that the support sheet defines a vent;
a fan configured to move air at a position below the elevated position; and
a ducting panel extending from the fan to the support sheet, the ducting panel defining a plenum fluidly connecting the fan to the vent, the plenum configured to guide air moved by the fan through the vent for cooling an area above the support sheet.

2. The elevated cot of claim 1, wherein the ducting panel comprises a first portion connected to the fan and an end portion connected to the support sheet.

3. The elevated cot of claim 2, wherein the second portion is joined to the support sheet at a joint circumscribing the vent.

4. The elevated cot of claim 3, wherein the second portion is captured in the frame assembly.

5. The elevated cot of claim 3, wherein the second portion is stitched to the support sheet at the joint.

6. The elevated cot of claim 1, wherein guiding the air moved by the fan through the vent comprises redirecting the flow of air from a substantially horizontal direction to a more vertical direction.

7. The elevated cot of claim 1, wherein the ducting panel drapes from the support sheet.

8. The elevated cot of claim 1, wherein the support sheet and the ducting panel are formed from different types of material.

9. The elevated cot of claim 8, wherein ducting panel is less permeable than the support sheet.

10. The elevated cot of claim 1, wherein the frame assembly further comprises a perimeter shield surrounding the perimeter frame and support sheet.

11. The elevated cot of claim 10, wherein the fan comprises a fan housing having an upper wall and a clip connected to the upper wall configured to clip onto the perimeter shield for supporting the fan on the elevated cot below the elevated position.

12. The elevated cot of claim 11, wherein the clip is configured to suspend the fan from the perimeter shield.

13. A fan for cooling an elevated pet cot, the elevated pet cot comprising a frame assembly for supporting a support sheet at an elevated position, the frame assembly comprising a perimeter frame and a perimeter shield surrounding the perimeter frame, the fan comprising:
one or more air movers; and
a fan housing receiving each air mover; and
a clip configured to clip onto the perimeter shield to support the fan on one side of the elevated pet cot.

14. The fan of claim 13, wherein the fan housing comprises an upper wall, a lower wall opposite the upper wall, an inlet side, and an outlet side opposite the inlet side, the inlet side and the outlet side each defining openings, each air mover being received between the upper wall and the lower wall and between the inlet side and the outlet side such that the air mover is configured to move air by drawing air into the fan housing through the openings in the inlet wall and discharging the air from the fan housing through the openings in the outlet wall.

15. The fan of claim 14, wherein the clip is connected to the upper wall.

16. The fan of claim 15, wherein the clip comprises an L-shaped clip arm comprising an upstanding segment and a cantilevered segment, the cantilevered segment being vertically spaced apart from the upper wall to define a clipping space therebetween, the clipping space having a height less than ½″.

17. The fan of claim 15, wherein the clip has a height above the upper wall less than ¾″.

18. The fan of claim 13, wherein the perimeter shield comprises a perimeter shield member having an L-shaped cross section including a horizontal portion and a vertical portion, and wherein the perimeter frame comprises a perimeter frame member nested in the L-shaped cross section such that the perimeter frame member is above the horizontal portion and beside the vertical portion, wherein the clip is configured to clip onto the perimeter shield member in a gap between the perimeter shield member and the perimeter frame member.

19. The fan of claim 18, wherein the clip is configured to clip onto the horizontal portion of the perimeter shield member such that an entirety of the fan is below the perimeter frame member.

20. Bedding replacement for an elevated pet cot, the bedding replacement comprising:
a rectangular support sheet having four looped side margins for receiving four perimeter frame members of a frame assembly of the elevated pet cot to stretch the support sheet on the frame assembly at an elevated position, at least a portion of the support sheet being made of permeable fabric such that the support sheet defines a vent;
ducting panel having length extending from a first end portion to a second end portion, the second end portion of the being joined to support sheet at a joint extending around the vent, the first end portion of the ducting panel configured to connect to a fan positioned below the support sheet adjacent one of the looped side margins of the support sheet, the ducting panel configured to define a plenum for fluidly connecting the fan to the vent, the plenum configured to guide air moved by the fan to pass through the vent for cooling a pet resting on the support sheet.
